(19) United States
(12) Patent Application Publication
(10) Pub. No.: US 2026/0181566 A1
(43) Pub. Date: Jun. 25, 2026

(54) SYNCHRONIZATION OF NODES AND WIRED SUBSYSTEMS IN WIRELESS NETWORKS

(71) Applicant: Silicon Laboratories Inc., Austin, TX (US)

(72) Inventors: Hasan Ali Stationwala, Hyderabad (IN); Atul Suresh Joshi, Pune (IN); Jitesh Rachamadugu, Hyderabad (IN); Lakshmi Shanmukha Dheeraj Kumar Karanam, Bangalore (IN); Ayan Bandhu Ghosh, Dum Dum (IN)

(21) Appl. No.: 18/991,847

(22) Filed: Dec. 23, 2024

(51) Int. Cl. H04W 56/00; H04J 3/06

(52) U.S. Cl. CPC H04W 56/001; H04J 3/0661

(57) ABSTRACT

Timing synchronization techniques provide a common time base between nodes and subsystems of nodes of wireless local area networks. The techniques are applicable to wireless local area networks with a fixed transmitter delay protocol or with a variable transmitter delay protocol. The techniques synchronize time between integrated circuit subsystems with asynchronous timers (e.g., a host integrated circuit device and a controller integrated circuit device) including subsystems with hardware timestamping support and subsystems without hardware timestamping support. Each node in the network is configured as a timing synchronization client with respect to an uplink node and may serve as a timing synchronization server with respect to a downlink node, which may be used in a serial chain of devices. A single timing synchronization server can synchronize to multiple downlink timing clients, which may serve as a timing synchronization servers to other downlink timing clients, thereby supporting tree topologies.

### BACKGROUND

### Field of the Invention

This application relates to wireless communications systems in general, and more particularly to techniques for synchronization of integrated circuit devices and nodes in wireless communications networks.

### Description of the Related Art

In general, local area wireless networks include nodes having at least one integrated circuit device operating using free-running timers that do not have a common time base. Computer networks of devices having free-running clocks use Precision Time Protocol (PTP) (i.e., an IEEE Standard for a Precision Clock Synchronization Protocol for Networked Measurement and Control Systems, e.g., IEEE Std. 1588™-2019) for clock synchronization throughout a computer network with relatively high precision and potentially high accuracy to provide precise time coordination in applications that require precise timing but lack access to satellite navigation signals (e.g., telecommunications, financial transactions, industrial automation, or other networks).

In a computer network compliant with PTP, a master device sends a sync message at time t₁ to a slave device. The master device sends a follow-up message including precise timestamp t₁ to the slave device. The slave device sends a delay request message at time t₂ to the master device. The master device responds with a delay response message, which includes timestamps t₃ and t₄. To synchronize the slave device with the master device, the round-trip delay d is calculated using the timestamps from the messages (e.g., d=((t₄−t₁)−(t₃−t₂))/2, where (t₄−t₁) is the total time from the master sending the sync message to the master receiving the delay request message, and (t₃−t₂) is the time taken by the slave device to send the delay request message and receive the delay response message. The offset o between the master clock and the slave clock is calculated (e.g., o=((t₂−t₁)+(t₃−t₄))/2, which is the difference in time between the master clock and the slave clock. The slave device adjusts its clock by adding the calculated offset, o, to its current time to synchronize with the clock of the master device.

Although PTP is designed to provide precise time synchronization across a network, in a jittery network (i.e., a network having substantial variability in packet transmission times), variable network delay, packet loss, or asymmetric path delays, impact performance. For example, jitter causes fluctuations in the time it takes for packets to travel between master devices and slave devices. Variable delays can cause inaccurate calculations of the round-trip delay and offset, resulting in poor synchronization accuracy. High jitter increases the likelihood of packet loss, which uses lost sync, follow-up, delay request or delay response messages that disrupt the synchronization process and causing the slave clock to drift. Jitter can cause asymmetry in the network paths taken by PTP messages. If forward and reverse paths have different delays, then the calculated offset may be incorrect and causes synchronization errors. Accordingly, improved techniques for synchronization are desired.

### SUMMARY OF EMBODIMENTS OF THE INVENTION

In at least one embodiment, a method for synchronizing nodes in a wireless network includes receiving an indication of a wireless network time from a first node of the wireless network by a second node of the wireless network and updating a derived wireless network time at the second node based on a current local timestamp, the indication of the wireless network time, and a timestamp corresponding to receipt of a periodic management packet. The method may include receiving the periodic management packet and the indication may be received in the periodic management packet. The method may include receiving the periodic management packet and receiving a follow-up packet after receiving the periodic management packet and the indication being received in the follow-up packet. The indication may correspond to an actual wireless network time of transmission of the periodic management packet by the first node. The method may include receiving an anticipated local timestamp corresponding to a transmission of the periodic management packet and an actual local timestamp corresponding to the transmission of the periodic management packet. The derived wireless network time may be updated further based on the anticipated local timestamp and the actual local timestamp.

The second node may include a first integrated circuit device and a second integrated circuit device and the first integrated circuit device may determine the derived wireless network time. The method may include synchronizing the first integrated circuit device with the second integrated circuit device according to the derived wireless network time.

The synchronizing may include sending, by the first integrated circuit device, to the second integrated circuit device, a request to trigger a general-purpose input/output pin of the first integrated circuit device. The synchronizing may include polling, by the first integrated circuit device, the general-purpose input/output pin for a trigger from the second integrated circuit device. The synchronizing may include sending, by the first integrated circuit device to the second integrated circuit device, a first timestamp corresponding to the trigger of the general-purpose input/output pin. The first timestamp may be used by the second integrated circuit device to determine a local wireless network time.

The synchronizing may include receiving, by the second integrated circuit device, the request to trigger the general-purpose input/output pin of the first integrated circuit device. The synchronizing may include triggering, by the second integrated circuit device, the general-purpose input/output pin of the first integrated circuit device in response to receiving the request and storing a second timestamp corresponding to the triggering. The synchronizing may include updating the local wireless network time based on a difference between the second timestamp and the first timestamp received by the second integrated circuit device.

The synchronizing may include triggering, by the first integrated circuit device, a general-purpose input/output pin of the second integrated circuit device. The synchronizing may include capturing, by the second integrated circuit device, a first timestamp corresponding to the triggering of the general-purpose input/output pin. The synchronizing may include receiving a second timestamp from the first integrated circuit device, the second timestamp corresponding to the triggering by the first integrated circuit device. The first timestamp and the second timestamp may be used as indicators of the wireless network time.

In at least one embodiment, a wireless network includes a first node having a radio frequency interface and a subsystem configured to use a time signal. The first node is configured to receive an indication of a wireless network time from a second node of the wireless network and is configured to update a derived wireless network time based on a current local timestamp of the time signal, the indication of the wireless network time, and a timestamp of the time signal corresponding to receipt of a periodic management packet. The first node is further configured to receive an anticipated local timestamp corresponding to a transmission of the periodic management packet and an actual local timestamp corresponding to the transmission of the periodic management packet. The derived wireless network time is updated further based on the anticipated local timestamp and the actual local timestamp. The indication may correspond to an actual wireless network time of transmission of the periodic management packet by the first node. The wireless network may include the second node, which may be configured to transmit the periodic management packet. The indication of the wireless network time, an anticipated local timestamp, and an actual local timestamp may be included in the periodic management packet or in a follow-up packet transmitted after transmission of the periodic management packet.

The radio frequency interface and a first portion of the subsystem may be included in a first integrated circuit device, and a second portion of the subsystem may be included in a second integrated circuit device. The second integrated circuit device may synchronize with the first integrated circuit device using the derived wireless network time. The radio frequency interface and a first portion of the subsystem may be included in a first integrated circuit device, and a second portion of the subsystem may be included in a second integrated circuit device. The first integrated circuit device may include a general-purpose input/output pin and may be configured to send to the second integrated circuit device, a request to trigger the general-purpose input/output pin, and may be configured to poll the general-purpose input/output pin for a trigger from the second integrated circuit device, and may be configured to send to the second integrated circuit device, a first timestamp corresponding to the trigger of the general-purpose input/output pin. The first timestamp may be used by the second integrated circuit device to determine the wireless network time.

In at least one embodiment, a method for synchronizing integrated circuit devices in a wireless network includes receiving from a first integrated circuit device of a first node, by a second integrated circuit device of the first node, a timestamp from the first integrated circuit device. The method includes updating a local wireless network time of the second integrated circuit device based on the timestamp. The method may include sending, by the first integrated circuit device, to the second integrated circuit device, a request to trigger a general-purpose input/output pin of the first integrated circuit device. The method may include polling, by the first integrated circuit device, the general-purpose input/output pin for a trigger from the second integrated circuit device. The method may include sending the timestamp by the first integrated circuit device to the second integrated circuit device, the timestamp corresponding to the trigger of the general-purpose input/output pin. The method may include receiving, by the second integrated circuit device, a trigger of a general-purpose input/output pin of the second integrated circuit device. The method may include receiving by the second integrated circuit device, the timestamp from the first integrated circuit device. The timestamp corresponds to the trigger of the general-purpose input/output pin.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of nodes communicatively coupled in a wireless network.

FIG. 2 illustrates a functional block diagram of a time server node in communication with client nodes.

FIG. 3 illustrates a functional block diagram of a tree configuration of a time server node and client nodes.

FIG. 4 illustrates a functional block diagram of a node including multiple subsystems operating with independent timers.

FIG. 5 illustrates a message exchange between nodes of the wireless network with a fixed transmission delay protocol consistent with at least one embodiment of the invention.

FIG. 6 illustrates a message exchange between nodes of the wireless network with variable transmission delay protocol consistent with at least one embodiment of the invention.

FIG. 7 illustrates a message exchange between integrated circuit devices of a node of a wireless network including a host device without a timer capture module consistent with at least one embodiment of the invention.

FIG. 8 illustrates a message exchange between integrated circuit devices of a node of a wireless network including a host device with a timer capture module consistent with at least one embodiment of the invention.

FIG. 9 illustrates a message exchange of integrated circuit devices of a node of a wireless network for periodic synchronization of subsystems consistent with at least one embodiment of the invention.

The use of the same reference symbols in different drawings indicates similar or identical items.

### DETAILED DESCRIPTION

Timing synchronization techniques provide a common time base between nodes and subsystems of nodes of wireless local area networks. The techniques are applicable to wireless local area networks with a fixed transmitter delay protocol or with a variable transmitter delay protocol (e.g., Clear Channel Assessment (CCA)). The techniques synchronize time between integrated circuit subsystems with asynchronous timers (e.g., a host integrated circuit device and a controller integrated circuit device) including subsystems with hardware timestamping support and subsystems without hardware timestamping support. Each node in the network is configured as a timing synchronization client with respect to an uplink node and may serve as a timing synchronization server with respect to a downlink node, which may be used in a serial chain of devices. A single timing synchronization server can synchronize to multiple downlink timing clients, which may serve as a timing synchronization servers to other downlink timing clients, thereby supporting tree topologies.

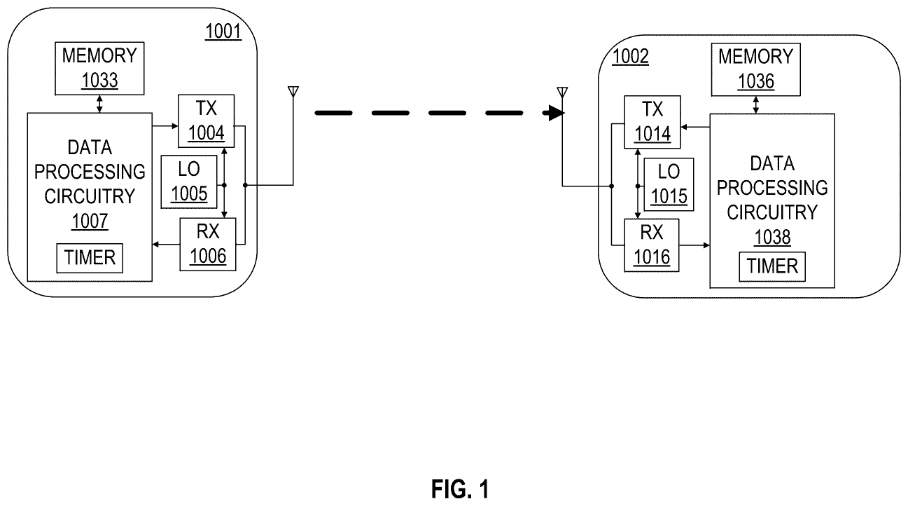

A typical Internet of Things (IoT) wireless communications device-based product is operable according to a wireless protocol such as an IEEE Standard 802.11 based protocol (Wi-Fi®), IEEE Standard 802.15.4 based protocols (Zigbee® and Thread), Bluetooth® Classic, Bluetooth® Low Energy/Bluetooth (BLE/BT) or other local area wireless communications protocol. Referring to FIG. 1, in at least one embodiment, wireless network 1000 includes time server node 1001 and client node 1002, which are wireless devices compliant with Bluetooth Core Specification Version 5.2 or later. Time server node 1001 includes transmitter 1004, receiver 1006, data processing circuitry 1007, memory 1033, and local oscillator 1005. Client node 1002 includes transmitter 1014, receiver 1016, data processing circuitry 1038, memory 1036, and local oscillator 1015. Local oscillator 1005 and local oscillator 1015 provide signals used in functions of time server node 1001 and client node 1002, respectively. In addition, time server node 1001 and client node 1002 each use a corresponding free-running timer to track time and may be included in corresponding data processing circuity or other portion of the corresponding node. In an embodiment of wireless network 1000, additional wireless communications devices (not shown) of wireless network 1000 are similar to time server node 1001 and client node 1002. In at least one embodiment of client node 1002, transmitter 1014, receiver 1016, local oscillator 1015, data processing circuitry 1038, and memory 1036 are included in a controller integrated circuit device implementing a link layer of a communications protocol and implementing a physical layer (RF and PHY) of the communications protocol, which controls radio frequency communications.

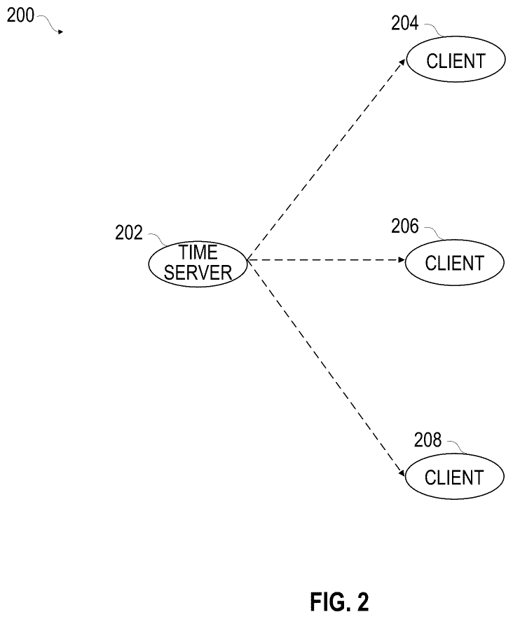

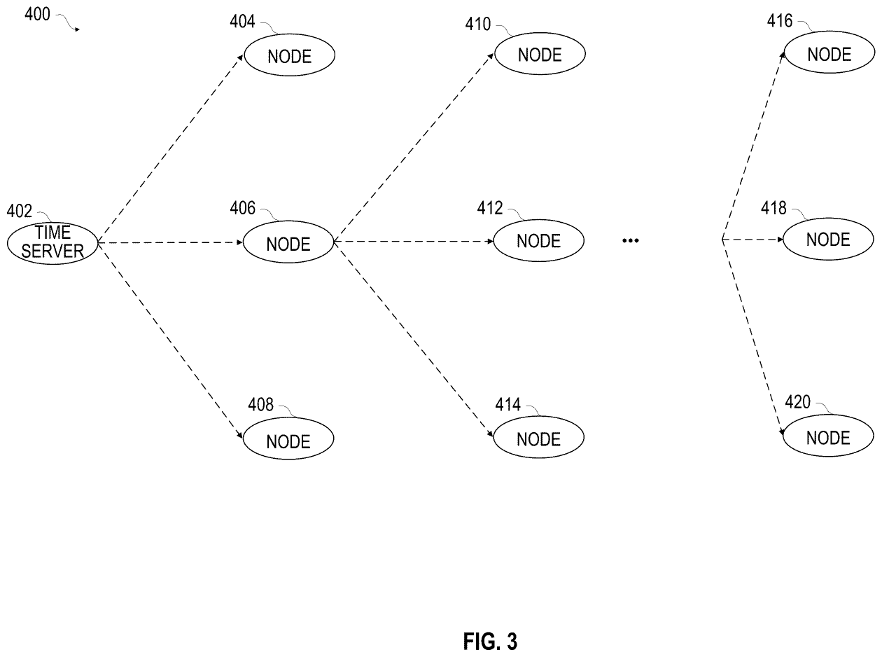

Referring to FIG. 2, wireless network 200, which may be used in Internet of Things (IoT) applications, has a star topology. Time server 202 provides each client node in the network with data packets that are transmitted consistent with the wireless local area network protocol. Each of client nodes 204, 206, and 208 receives the same protocol data units (PDUs). Another configuration of a wireless local area network has extended range by including nodes in a series chain configured in a tree topology, as illustrated in FIG. 3. In an embodiment, node 402 is configured as a timing synchronization node that behaves as a time server to nodes 404, 406, and 408, which are in communication range of node 402 and receive data packets transmitted by node 402 using a link consistent with a wireless local area network protocol. Node 406, which is configured as a timing synchronization client with respect to node 402, is also configured as a timing synchronization time server with respect to nodes 410, 412, and 414, which are configured as timing synchronization clients with respect to node 406. Nodes 416, 418, and 420 are configured as timing synchronization clients with respect to a node that transmits the timing synchronization packets received by nodes 416, 418, and 420.

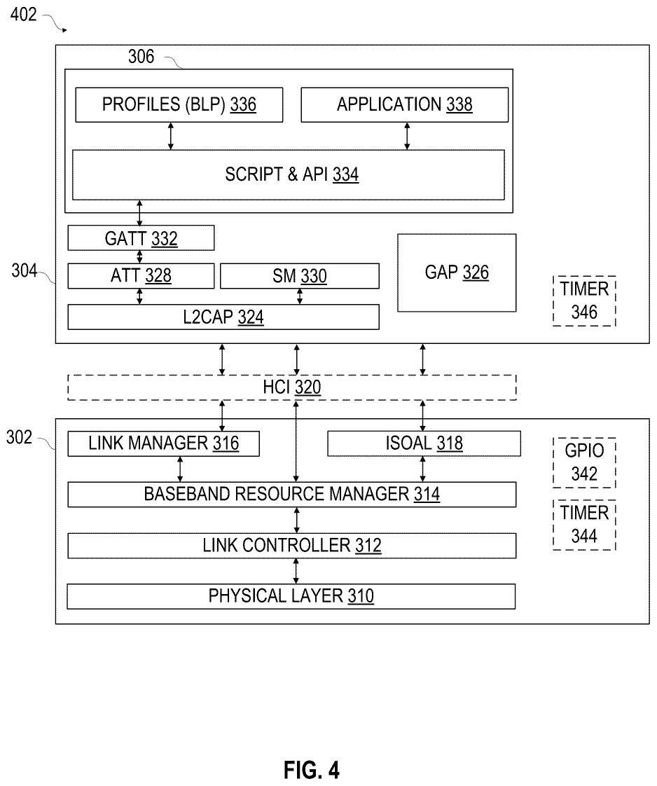

Referring to FIG. 4, in at least one embodiment of a wireless network, each node of the wireless network implements a BLE architecture, e.g., using separate integrated circuit devices for controller 302 and host 304. Each of the separate integrated circuit devices includes a free-running clock and operates using separate timers or time bases. In some embodiments, node 402 incorporates functionality of controller 302 and host 304 in a single integrated circuit device and controller 302 and host 304 are synchronized using a common clock or timer circuit.

In an embodiment, controller 302 includes physical layer 310 (e.g., RF radio) and link controller 312, which are responsible for sending or receiving packets over the air by defining the use of a radio, including modulation schemes, frequency bands, channel use, and transmitter and receiver characteristics, e.g., as described in Bluetooth Core Specification Version 5.3, Vol. 6: Low Energy Controller. Physical layer 310 transmits and receives packets of information using the physical channel and transforms a stream of data to and from the physical channel and the baseband signals into required formats. The physical layer defines the use of a radio (e.g., transmitter and receiver), including modulation schemes, frequency bands, channel use, and transmitter and receiver characteristics. Link controller 312 implements a link layer protocol, which defines the air interface packet formats, bit stream processing procedures, a state machine and protocols for over-the-air communication, and link control. Link controller 312 encodes and decodes packets from a data payload and parameters related to a physical channel, logical transport, and logical link.

Baseband resource manager 314 negotiates access contracts, i.e., commitments to deliver a predetermined Quality-of-Service (QoS) that is required by a user application to provide expected performance. Baseband resource manager 314 also includes a scheduler that grants time on physical channels to entities that have negotiated an access contract. Link manager 316 creates, modifies, and releases logical links (and associated logical transports, if required) and updates parameters related to physical links between devices. In an embodiment, node 402 implements Host-to-Controller Interface (HCI) 320, which is a standard service interface.

In an embodiment, host 304 includes Generic Framework (GF) 306, Logical Link Control and Adaptation Protocol (L2CAP) resource manager 324, Attribute Protocol (ATT) 328, Generic Attribute Protocol (GATT) 332, Generic Access Profile (GAP) 326, and Security Manager (SM) 330. L2CAP resource manager 324 manages ordering of submission of BLE packet protocol data unit (PDU) fragments and some relative scheduling between channels to ensure that L2CAP channels with QoS commitments are not denied access to the physical channel due to controller resource exhaustion. L2CAP resource manager 324 polices traffic to ensure that applications submit L2CAP SDUs within bounds of negotiated QoS settings. In an embodiment of node 402, GATT 332 defines the way that two BLE devices communicate data using services and characteristics. In an embodiment, GATT 332 uses a generic data protocol stored in ATT 328, which is used to store services, characteristics and related data in a simple lookup table using 16-bit identifiers for each entry in the table. SM 330 implements a peer-to-peer protocol for generating encryption keys and identity keys and generates random addresses and resolves random addresses to known device identities.

GAP 326 represents base functionality common to all Bluetooth devices, e.g., modes and access procedures used by transports, protocols, and application profiles. GAP services include device discovery, connection modes, security authentication, associate models and service discovery. GF 306 includes Script and API 334, application 338, and profiles 336, which adds application specific information to GF 306. For example, profiles 336 include an audio control profile, e.g., as described in Basic Audio Profile (BAP), which defines procedures for controlling audio streams by using GATT 332 and GAP 326 for devices that use BLE in audio-related scenarios. In addition to circuitry configured to execute the software of a communications protocol, embodiments of host 304 include timer 346 and embodiments of controller 302 include timer 344 and general purpose input/output 342.

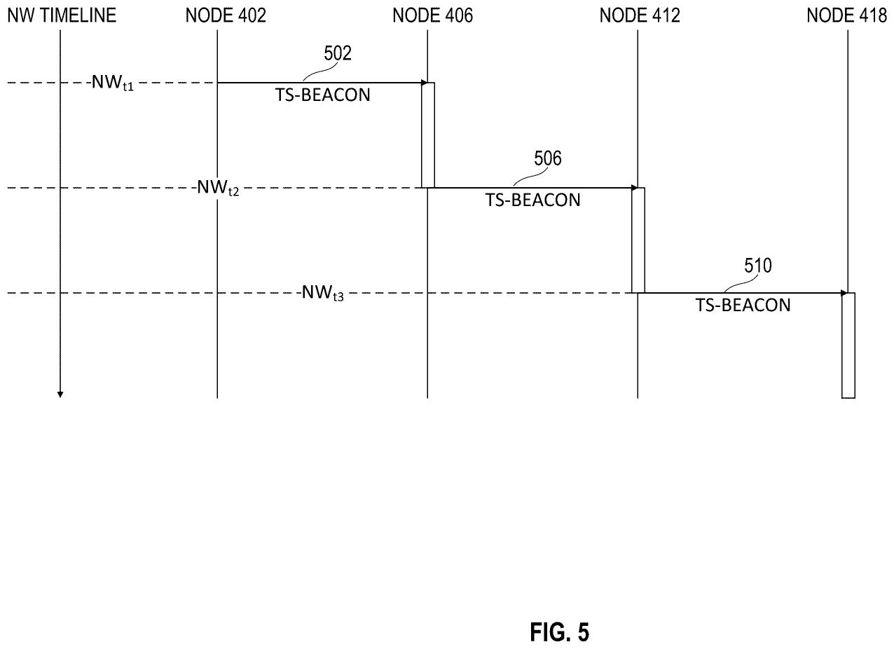

Referring to FIGS. 3 and 5, in at least one embodiment of wireless communications network 400, nodes of wireless communications network 400 operate using free running time signals and implement a communications protocol with a fixed delay transmission, i.e., do not follow a Clear Channel Assessment (CCA) protocol or other protocol (e.g., Carrier Sense Multiple Access with Collusion Avoidance) that introduces a variable delay into a transmission by determining whether a wireless medium is currently busy or occupied before transmitting on that wireless medium to prevent collisions with other devices using the same wireless medium. Node 402 is configured as a time server (i.e., a master node) and includes hardware that implements the network time, i.e., a digital record of the current time of the wireless network that is used to synchronize all nodes and subsystems of nodes in the wireless network. Nodes 406, 412, and 418 are wirelessly coupled in series and each of nodes 406, 412, and 418 are configured as client nodes (i.e., slave nodes) with respect to node 402. In an embodiment, node 402 transmits time synchronization beacon 502 (i.e., a periodically transmitted management packet, e.g., a beacon frame of a Wi-Fi protocol or an advertisement packet of a Bluetooth protocol) that includes network timestamp NWₜ₁. In at least one embodiment, the physical layer of node 402 inserts network timestamp NWₜ into time synchronization beacon 502 before transmission of time synchronization beacon 502. The physical layer of node 406 latches a local timestamp corresponding to the receipt of the time synchronization beacon 502 at node 406 (TSRX₅₀₂) using a timer and a storage element or other memory of node 406. Assuming that the propagation delay between node 402 and node 406 is negligible (e.g., less than a couple of microseconds in a target IoT application) and that the delay between a controller of node 402 providing a packet to a physical interface of node 402 is fixed, node 406 computes a time offset (TO₄₀₆) between the local timer of node 406 and the network time based on the local timestamp corresponding to the receipt of the time synchronization beacon 502 at node 406 (TSRX₅₀₂) and the network timestamp (NWₜ₁) included in time synchronization beacon 502. That is,
TO₄₀₆=TSRX₅₀₂−NWₜ₁.
   The derived network time NWₜₙ at node x at any moment in time tₙ is:
NWₜₙ=TS_{node|tn}+TO_{node},
where TS_{node|tn} is a current timestamp of a timer in node x at time tₙ.
   For example, NWₜ₂=TS_{406|t2}+TO₄₀₆, where NWₜ₂ is the network time derived by node 406 at time t₂.

Similarly, node 406 transmits time synchronization beacon 506 including NWₜ₂. Node 412 latches a local timestamp corresponding to the receipt of the time synchronization beacon 506 at node 412 (TSRX₅₀₆) using a timer and a storage element or other memory of node 412. Node 412 computes a time offset (TO₄₁₂) between the local timer of node 412 and the network time, based on local timestamp corresponding to the receipt of the time synchronization beacon 506 at node 412 (TSRX₅₀₆) and the network timestamp (NWₜ₂) included in time synchronization beacon 506. Node 412 transmits time synchronization beacon 510 including NWₜ₃. Node 418 latches a local timestamp corresponding to the receipt of the time synchronization beacon 510 at node 418 (TSRX₅₁₀) using a storage element or other memory of node 418. Node 418 computes a time offset (TO₄₁₈) between the local timer of node 418 and the network time, based on the local timestamp corresponding to the receipt of the time synchronization beacon 510 at node 418 (TSRX₅₁₀) and the network timestamp (NWₜ₃) included in time synchronization beacon 510. That is,
TO₄₁₂=TSRX₅₀₆−NWₜ₂,
NWₜₙ=TS_{412|tn}+TO₄₁₂,
TO₄₁₈=TSRX₅₁₀−NWₜ₃, and
NWₜₙ=TS_{418|tn}+TO₄₁₈.
   Node 412 and node 418 use the corresponding time offset to determine the network time whenever the network time base is needed for synchronization of operations. For example, time offsets TO₄₁₂ and TO₄₁₈ are saved in corresponding storage elements at respective nodes and are combined with a corresponding local time signal of the respective node for every use of network time. In other embodiments, the time offsets TO₄₁₂ and TO₄₁₈ are added to a count value to synchronize the local time signal with the network time, or other suitable technique is used to synchronize a local timer of a node to the network time.

In some embodiments of wireless communications network 400, the network time might not be included in the time synchronization beacon, and instead is transmitted in a follow-up packet. The receiving node stores the local timestamp coincident with receipt of the time synchronization beacon but performs the time offset computation in response to receiving the network time in the follow-up packet. In at least one embodiment of wireless communications network 400, the network time is not transmitted and another indication of the network time is used. For example, a time server node may announce a fixed periodicity for transmission of the time synchronization beacon in a configuration phase and the nodes transmit a time synchronization beacon count in each time synchronization beacon or follow-up packet. The receiving node derives the current network time based on the knowledge of the periodicity and the beacon count.

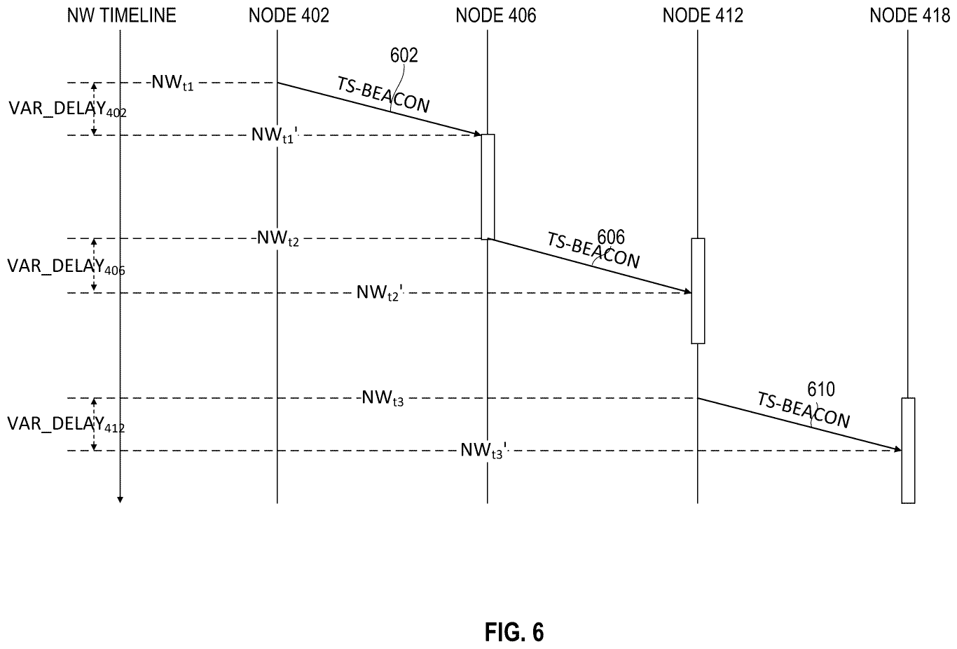

Referring to FIGS. 3 and 6, in at least one embodiment of wireless communications network 400, the network time transmitted in the time synchronization beacon or follow-up packet is not the actual time of transmission of the time synchronization beacon. That is, the time synchronization beacon or follow-up packet includes an anticipated network time of transmission (i.e., anticipated network time (NWₜₙ)) and the time synchronization beacon is actually transmitted at actual network time (NWₜₙ′). This is the result of wireless communications network 400 implementing a variable transmission delay protocol (e.g., CCA protocol or other variable transmission delay protocol) that delays actual transmission of a packet by the lower-most software layers and physical interface of the node while waiting for the physical channel to become available. However, the software layer responsible for forming the time synchronization beacons and for inserting a network timestamp into the time synchronization beacon cannot anticipate the variable transmission delay and hence cannot anticipate the network timestamp at the precise instant when transmission of the time synchronization beacon actually occurs. Accordingly, an embodiment of wireless communications network 400 includes timestamping hardware (e.g., in a physical layer) of the transmitting node to generate anticipated transmission timestamp TSTXₚ corresponding to the anticipated time of transmission of the time synchronization beacon p and actual transmission timestamp TSTXₚ′ corresponding to the actual time of transmission of the time synchronization beacon, and inserts those timestamps in a time synchronization beacon or follow-up packet. The receiving node determines the variable transmission delay and corrects the anticipated network time (NWₜₙ) to determine the actual network time (NWₜₙ′) using the variable delay:
NWₜₙ′=NWₜₙ+(TSTXₚ′−TSTXₚ).

In at least one embodiment, node 402 transmits anticipated network time NWₜ₁, anticipated transmission timestamp TSTX₆₀₂, and actual transmission timestamp TSTX₆₀₂′. Node 406 captures the timestamp of the local time of receipt of time synchronization beacon 602 (TSRX₆₀₂). The variable delay that occurred at the transmitting node during transmission of time synchronization beacon 602 is:
VAR_DELAY₄₀₂=TSTX₆₀₂′−TSTX₆₀₂.
   A time offset of the local time of node 406 from the network time (TO₄₀₆) equals the difference between the timestamp of the local time of receipt of time synchronization beacon 602 (TSRX₆₀₂) and the sum of the network timestamp (NWₜ₁) included in beacon 602 and variable delay VAR_DELAY₄₀₂ that time synchronization beacon 602 experienced at node 402:
TO₄₀₆=TSRX₆₀₂−(NWₜ₁+VAR_DELAY₄₀₂).
   The derived network time NWₜₙ at node 406 at any moment in time tₙ is:
NWₜₙ=TS_{406|tn}+TO₄₀₆,
where TS_{406|tn} is a current timestamp of a timer in node 406 at time NWₜₙ.
   For example, NWₜₙ=TS_{406|tn}+TO₄₀₆, where NWₜₙ is the network time derived by node 406 at time tₙ.

Similarly, node 406 transmits anticipated network time NWₜ₂, anticipated transmission timestamp TSTX₆₀₆, and actual transmission timestamp TSTX₆₀₆′. Node 412 captures the timestamp of the local time of receipt of time synchronization beacon 606 (TSRX₆₀₆). The variable delay that occurred at the transmitting node during transmission of time synchronization beacon 606 is:
VAR_DELAY₄₀₆=TSTX₆₀₆′−TSTX₆₀₆.
   A time offset of the local time of node 412 from the network time (TO₄₁₂) equals the difference between the timestamp of the local time of receipt of time synchronization beacon 606 (TSRX₆₀₆) and the sum of the network timestamp (NWₜ₂) included in beacon 606 and variable delay VAR_DELAY₄₀₆ that time synchronization beacon 606 experienced at node 406:
TO₄₁₂=TSRX₆₀₆−(NWₜ₂+VAR_DELAY₄₀₆).
   The derived network time NWₜₙ at node 412 at any moment in time tₙ is:
NWₜₙ=TS_{412|tn}+TO₄₁₂,
where TS_{412|tn} is a current timestamp of a timer in node 412 at time tₙ.
   For example, NWₜₙ=TS_{412|tn}+TO₄₁₂, where NWₜₙ is the network time derived by node 412 at time tₙ.

Node 412 transmits anticipated network time NWₜ₃, anticipated transmission timestamp TSTX₆₁₀, and actual transmission timestamp TSTX₆₁₀′. Node 418 captures the timestamp of the local time of receipt of time synchronization beacon 610 (TSRX₆₁₀). The variable delay that occurred at the transmitting node during transmission of time synchronization beacon 610 is:
VAR_DELAY₄₁₂=TSTX₆₁₀′−TSTX₆₁₀.
   A time offset of the local time of node 418 from the network time (TO₄₁₈) equals the difference between the timestamp of the local time of receipt of time synchronization beacon 610 (TSRX₆₁₀) and the sum of the network timestamp (NWₜ₃) included in beacon 610 and the variable delay VAR_DELAY₄₁₂ that time synchronization beacon 610 experienced at node 412:
TO₄₁₈=TSRX₆₁₀−(NWₜ₃+VAR_DELAY₄₁₂).
   The derived network time NWₜₙ at node 418 at any moment in time tₙ is:
NWₜₙ=TS_{418|tn}+TO₄₁₈,
where TS_{418|tn} is a current timestamp of a timer in node 418 at time tₙ.
   For example, NWₜₙ=TS_{418|tn}+TO₄₁₈, where NWₜₙ is the network time derived by node 418 at time tₙ.

In at least one embodiment, rather than the receiving node determining the variable transmission delay and correcting the anticipated network time (NWₜₙ) to determine the actual network time (NWₜₙ′) using the variable delay, the transmitting node determines the variable transmission delay and corrects the anticipated network time (NWₜₙ) to determine the actual network time (NWₜₙ′) using the variable delay:
NWₜₙ′=NWₜₙ+(TSTXₚ′−TSTXₚ).
   The transmitting node (e.g., node 402, node 406, or node 412) records the anticipated transmission timestamp TSTXₚ, the actual transmission timestamp TSTXₚ′, and the anticipated network time at the time of transmit (NWₜₙ). The transmitting node determines the actual network time (NWₜₙ′) by adding the difference between the actual transmission timestamp TSTXₚ′ and the anticipated transmission timestamp TSTXₚ and sends an indication of the actual network time at the time of transmission of the time synchronization beacon in a follow-up message to a receiving node (e.g., node 406, node 412, or node 418, respectively).

In at least one embodiment, a node comprises multiple subsystems or multiple integrated circuit die, e.g., a control integrated circuit die and host integrated circuit die in a System-on-Chip (SoC), and each subsystem or integrated circuit die operates using an independent time signal without a common time base. Techniques for establishing a common time base or synchronizing all subsystems or integrated circuit die in an SoC to a network time base include embodiments for integrated circuit die (e.g., host) without a timer capture module and embodiments for integrated circuit die (e.g., host) with timer capture modules (e.g., Peripheral Reflex System of EFR32FG23 Wireless SoC Family of products provided by Silicon Laboratories Inc.).

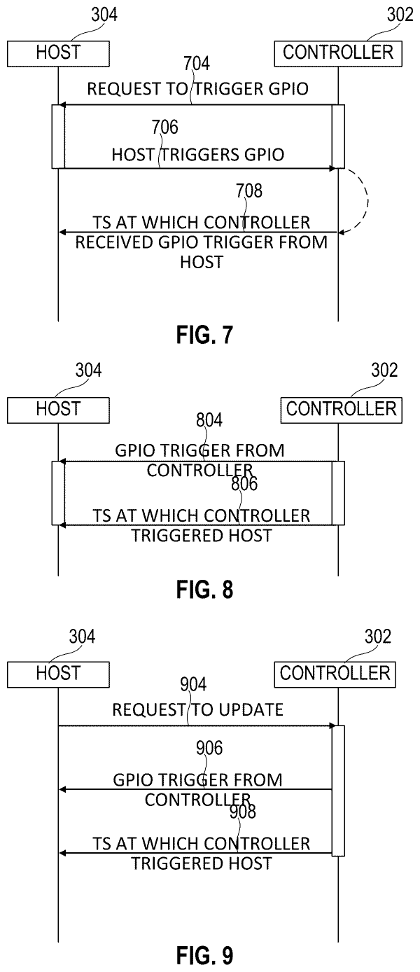

Referring to FIGS. 4 and 7, in an embodiment, node 402 includes a timer that provides the network time or is used to derive the network time, as described above. In an embodiment, host 304 does not include a time capture circuit. Controller 302, which includes a radio and circuits implementing a wireless communications protocol, as described above, initiates synchronization of the integrated circuit die of node 402 by sending (e.g., using HCI 320) a request for host 304 to trigger a general-purpose input/output of controller 302 (704). In an embodiment, after sending the request to trigger, controller 302 polls its general-purpose input/output to detect a trigger from host 304. In response to the request to trigger, host 304 triggers the general-purpose input/output of controller 302 using any signal or sequence of signals consistent with the general-purpose input/output interface of controller 302 (e.g., drive, reset, or toggle a pin) (706) and reads a timestamp (TS_{HOST}) coinciding with detection of the trigger. In an embodiment, the general-purpose input/output is triggered using a platform-specific general-purpose input/output driver and edge triggering or level triggering is used. Controller 302 captures the network time at which it receives the trigger of the general-purpose input/output and (TS_{CONTROLLER}) and transmits that information to host 304, e.g., using HCI 320 (708). In response to receiving the details from controller 302, host 304 determines a time offset (e.g., TO=TS_{HOST}−TS_{CONTROLLER}) between the host time and the time base of controller 302. Host 304 stores and uses this offset to synchronize events (e.g., events of application layers executing on host 304) to the time base of controller 302 (e.g., network time).

Referring to FIG. 8, in an embodiment, host 304 includes a time capture circuit. Controller 302 initiates synchronization of the integrated circuit die of node 402, e.g., by triggering a general-purpose input/output of host 304 consistent with the general-purpose input/output interface of host 304 (e.g., drives, resets, or toggles a pin) (804), host 304 captures a timestamp coinciding with receiving the trigger (TS_{HOST}) and waits for a message from controller 302. Controller 302 captures a timestamp of a network time (or other time base) at which it triggered the general-purpose input/output of controller 302 (TS_{CONTROLLER}) and transmits that information or indicators of that information to host 304 (806), e.g., using HCI 320. In response to receiving the information or indicators thereof from controller 302, host 304 determines a time offset (e.g., TO=TS_{HOST}−TS_{CONTROLLER}) between the host time and the time base of controller 302. Host 304 stores and uses this offset to synchronize events (e.g., events of application layers executing on host 304) to the time base of controller 302 (e.g., network time).

Referring to FIG. 9, host 304 periodically synchronizes to a time base of controller 302, which may be a network time of an associated wireless communications network. For example, host 304 transmits a request to update the time to controller 302 (e.g., via HCI 320) (904). Controller 302 triggers general-purpose input/output of host 304 (906). In response to the trigger, host 304 captures a timestamp coinciding with the trigger (TS_{HOST}). Controller 302 sends a timestamp coinciding with the trigger (TS_{CONTROLLER}) to host 304 (e.g., via HCI 320) (908). In response to receiving the timestamp from controller 302, host 304 determines a time offset (e.g., TO=TS_{HOST}−TS_{CONTROLLER}). Host 304 stores and uses this offset to synchronize events (e.g., events of applications executing on host 304) to the time base of controller 302 (e.g., a network time).

In an embodiment of a wireless communications network, nodes configured consistent with a BLE protocol are configured in a mesh network. The BLE mesh network relies on transmission and reception of broadcast advertisement packets for communication between nodes. Each node listens for advertisement packets from neighboring nodes and if the node is configured as a repeater, then it retransmits the packet for range extension. A random delay is introduced by each node before retransmission of the packet to reduce or eliminate over-the-air collision with transmissions from other nodes that are attempting to replay the same packet. Thus, the repeated packets are received by different nodes at different times and are executed at different times (e.g., in order of reception by each node). If the packet includes a command that turns on or turns off a lighting element of the receiving node and variance in the execution time is high, the random order in which the lighting elements are turned on or turned off can be perceived by the human eye with an effect referred to as a popcorn effect.

In an embodiment of the wireless communications network, the synchronization techniques described above are applied to the nodes of The BLE mesh network to reduce this popcorn effect introduced by the randomization of the transmit process. For example, one node of the mesh network is designated as a time server of the mesh network and the remainder of the nodes are configured as client nodes, which are synchronized to the network time of the time server. The time server announces its local time as the network time in a message included in a periodic advertisement packet (or follow-up packet). The client nodes derive the network time, as described above, and may send the network time in periodic advertisement packets. In an embodiment of the BLE mesh network, each client node configures a local timer based on an indication of the network time timestamp received in a periodic advertisement packet and the client node increments the corresponding local timer in response to every unit tick of the network time. In an embodiment of the BLE mesh network, rather than rely on the periodic advertisement packet for synchronization of the derived network timestamp, client nodes exchange the derived network timestamp using proprietary packets. Since each node continues to increment the derived network timestamp locally, the exchange need not be periodic.

In an embodiment of the BLE mesh network, an application appends a field specifying an execution time that is a network time at which the node should execute the command (e.g., a command that turns on or turns off a lighting element). The execution time is determined by the application with respect to the network time to provide sufficient time for the command to reach every node of the mesh network before the execution time occurs. Each node that receives the command waits until the network time equals the execution time before executing the command.

Thus, techniques for synchronizing nodes and subsystems or integrated circuit devices in a wireless communications network have been described. The techniques may be implemented using software executing on a processor (which includes firmware) or by a combination of software and hardware. Software, as described herein, may be encoded in at least one tangible (i.e., non-transitory) computer readable medium. As referred to herein, a tangible computer-readable medium includes at least a disk, tape, or other magnetic, optical, or electronic storage medium.

The description of the invention set forth herein is illustrative and is not intended to limit the scope of the invention as set forth in the following claims. The terms “first,” “second,” “third,” and so forth, as used in the claims, unless otherwise clear by context, are to distinguish between different items in the claims and do not otherwise indicate or imply any order in time, location, or quality. For example, “a first received signal” and “a second received signal,” do not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for synchronizing nodes in a wireless network, the method comprising:
receiving an indication of a wireless network time from a first node of the wireless network by a second node of the wireless network; and
updating a derived wireless network time at the second node based on a current local timestamp, the indication of the wireless network time, and a timestamp corresponding to receipt of a periodic management packet.

2. The method as recited in claim 1 further comprising:
receiving the periodic management packet,
wherein the indication is received in the periodic management packet.

3. The method as recited in claim 1 further comprising:
receiving the periodic management packet; and
receiving a follow-up packet after receiving the periodic management packet, wherein the indication is received in the follow-up packet.

4. The method as recited in claim 3 wherein the indication corresponds to an actual wireless network time of transmission of the periodic management packet by the first node.

5. The method as recited in claim 1 further comprising:
receiving an anticipated local timestamp corresponding to a transmission of the periodic management packet and an actual local timestamp corresponding to the transmission of the periodic management packet, and
wherein the derived wireless network time is updated further based on the anticipated local timestamp and the actual local timestamp.

6. The method as recited in claim 1,
wherein the second node includes a first integrated circuit device and a second integrated circuit device and the first integrated circuit device determines the derived wireless network time, and
wherein the method further comprises synchronizing the first integrated circuit device with the second integrated circuit device according to the derived wireless network time.

7. The method as recited in claim 6 wherein the synchronizing comprises:
sending, by the first integrated circuit device, to the second integrated circuit device, a request to trigger a general-purpose input/output pin of the first integrated circuit device;
polling, by the first integrated circuit device, the general-purpose input/output pin for a trigger from the second integrated circuit device; and
sending, by the first integrated circuit device to the second integrated circuit device, a first timestamp corresponding to the trigger of the general-purpose input/output pin,
wherein the first timestamp is used by the second integrated circuit device to determine a local wireless network time.

8. The method as recited in claim 7 wherein the synchronizing further comprises:
receiving, by the second integrated circuit device, the request to trigger the general-purpose input/output pin of the first integrated circuit device;
triggering, by the second integrated circuit device, the general-purpose input/output pin of the first integrated circuit device in response to receiving the request and storing a second timestamp corresponding to the triggering; and
updating the local wireless network time based on a difference between the second timestamp and the first timestamp received by the second integrated circuit device.

9. The method as recited in claim 6 wherein the synchronizing comprises:
triggering, by the first integrated circuit device, a general-purpose input/output pin of the second integrated circuit device;
capturing, by the second integrated circuit device, a first timestamp corresponding to the triggering of the general-purpose input/output pin; and
receiving a second timestamp from the first integrated circuit device, the second timestamp corresponding to the triggering by the first integrated circuit device,
wherein the first timestamp and the second timestamp are used as indicators of the wireless network time.

10. The method as recited in claim 6 further comprising:
periodically requesting, by the second integrated circuit device, an update of the indication of the wireless network time from the first integrated circuit device.

11. A wireless network comprising:
a first node comprising:
a radio frequency interface; and
a subsystem configured to use a time signal,
wherein the first node is configured to receive an indication of a wireless network time from a second node of the wireless network and is configured to update a derived wireless network time based on a current local timestamp of the time signal, the indication of the wireless network time, and a timestamp of the time signal corresponding to receipt of a periodic management packet.

12. The wireless network as recited in claim 11
wherein the first node is further configured to receive an anticipated local timestamp corresponding to a transmission of the periodic management packet and an actual local timestamp corresponding to the transmission of the periodic management packet, and
wherein the derived wireless network time is updated further based on the anticipated local timestamp and the actual local timestamp.

13. The wireless network as recited in claim 11 wherein the indication corresponds to an actual wireless network time of transmission of the periodic management packet by the second node of the wireless network.

14. The wireless network as recited in claim 11 further comprising:
the second node of the wireless network, the second node being configured to transmit the periodic management packet,
wherein the indication of the wireless network time, an anticipated local timestamp, and an actual local timestamp are included in the periodic management packet or in a follow-up packet transmitted after transmission of the periodic management packet.

15. The wireless network as recited in claim 11 wherein the radio frequency interface and a first portion of the subsystem are included in a first integrated circuit device, and a second portion of the subsystem is included in a second integrated circuit device, and the second integrated circuit device synchronizes with the first integrated circuit device using the derived wireless network time.

16. The wireless network as recited in claim 11
wherein the radio frequency interface and a first portion of the subsystem are included in a first integrated circuit device, and a second portion of the subsystem is included in a second integrated circuit device, and
wherein the first integrated circuit device comprises a general-purpose input/output pin and is configured to send to the second integrated circuit device, a request to trigger the general-purpose input/output pin, to poll the general-purpose input/output pin for a trigger from the second integrated circuit device, and to send to the second integrated circuit device, a first timestamp corresponding to the trigger of the general-purpose input/output pin,
wherein the first timestamp is used by the second integrated circuit device to determine the wireless network time.

17. The wireless network as recited in claim 11
wherein the radio frequency interface and a first portion of the subsystem are included in a first integrated circuit device, and a second portion of the subsystem is included in a second integrated circuit device, and the second integrated circuit device, and
wherein the first integrated circuit device is configured to trigger a general-purpose input/output pin of the second integrated circuit device,
wherein the second integrated circuit device comprises a timer capture circuit and is configured to capture a first timestamp corresponding to triggering of the general-purpose input/output pin and to receive a second timestamp from the first integrated circuit device, the second timestamp corresponding to the triggering by the first integrated circuit device,
wherein the second integrated circuit device is configured to use the first timestamp and the second timestamp as indicators of the wireless network time.

18. The wireless network as recited in claim 17 wherein the second integrated circuit device is configured to periodically request, an update of the indicators of the wireless network time from the first integrated circuit device.

19. A method for synchronizing integrated circuit devices in a wireless network, the method comprising:
receiving from a first integrated circuit device of a first node, by a second integrated circuit device of the first node, a timestamp from the first integrated circuit device; and
updating a local wireless network time of the second integrated circuit device based on the timestamp.

20. The method as recited in claim 19 further comprising:
sending, by the first integrated circuit device, to the second integrated circuit device, a request to trigger a general-purpose input/output pin of the first integrated circuit device;
polling, by the first integrated circuit device, the general-purpose input/output pin for a trigger from the second integrated circuit device; and
sending the timestamp by the first integrated circuit device to the second integrated circuit device, the timestamp corresponding to the trigger of the general-purpose input/output pin.
